(19) United States
(12) Patent Application Publication
(10) Pub. No.: US 2024/0281758 A1
(43) Pub. Date: Aug. 22, 2024

(54) SERVER ORDERING NEW CONSUMABLE FOR TARGET DEVICE, AS SERVICE, WHEN RESIDUAL QUANTITY OF CURRENTLY-USED CONSUMABLE IS LOWER THAN OR EQUAL TO THRESHOLD VALUE

(71) Applicant: BROTHER KOGYO KABUSHIKI KAISHA, Nagoya (JP)

(72) Inventors: YUTAKA TAKIJIRI, Nagoya (JP); TAICHIRO KIMOTO, Nagoya (JP); KOICHI TSUGIMURA, Nagoya (JP)

(73) Assignee: BROTHER KOGYO KABUSHIKI KAISHA, Nagoya (JP)

(21) Appl. No.: 18/441,468

(22) Filed: Feb. 14, 2024

(30) Foreign Application Priority Data
Feb. 20, 2023 (JP) 2023-024680

(51) Int. Cl. G06Q 10/087; G06Q 30/0601

(52) U.S. Cl. CPC G06Q 10/087; G06Q 30/0635

(57) ABSTRACT

A server communicates with a target device that consumes a consumable. A controller of the server receives a request to modify a target service for the target device to a first service from a second service. Each of the first and second services is a service in which a new consumable is to be ordered for the target device on the basis of a residual quantity of a currently-used consumable. The controller acquires specific information in response to the request. The specific information is related to an order placed for a new consumable while the target service has been set to the second service. The controller sets a first threshold value on the basis of the specific information, and orders, as a part of the first service, a new consumable for the target device when the residual quantity is lower than or equal to the first threshold value.

### REFERENCE TO RELATED APPLICATIONS

This application claims priority from Japanese Patent Application No. 2023-024680 filed on Feb. 20, 2023. The entire content of the priority application is incorporated herein by reference.

### BACKGROUND ART

Some printing services offer a flat-rate system or a pay-as-you-go system. For example, in a known technology, a printer can perform printing under the terms of a service agreement. This printer activates printing under such an agreement upon receiving an activation instruction from a server. Under the service agreement, the printer transmits information specifying the number of sheets printed and residual quantities of ink to the server, and the server performs processes such as a process to ship ink cartridges on the basis of this information, for example.

### SUMMARY

However, the above technology offers no consideration for changing from one printing service to another. Consequently, users may suffer loss in the event of a change in service, for example.

In view of the foregoing, it is an object of the present disclosure to provide a technology capable of preventing loss to a user when changing from one service to another.

In order to attain the above and other object, the present disclosure provides a server. The server includes a communication interface and a controller. The communication interface is configured to communicate with a target device. The target device is configured to consume a consumable. The controller is configured to perform: receiving a request to modify a target service for the target device to a first service from a second service different from the first service, each of the first service and the second service being a service in which a new consumable is to be ordered for the target device on the basis of a residual quantity related to a currently-used consumable in the target device; acquiring specific information in response to the request, the specific information being related to an order placed for a new consumable while the target service has been set to the second service for the target device; setting a first threshold value on the basis of the specific information; and ordering, as a part of the first service, a new consumable for the target device when the residual quantity is lower than or equal to the first threshold value.

According to another aspect, the disclosure provides a system. The system includes a first server and a second server. The first server is for providing a first service. The first server includes a first communication interface and a first controller. The first communication interface is configured to communicate with a target device. The target device is configured to consume a consumable. The second server is for providing a second service different from the first service. The second server includes a second communication interface and a second controller. The second communication interface is configured to communicate with the target device. Each of the first service and the second service is a service in which a new consumable is to be ordered for the target device on the basis of a residual quantity related to a currently-used consumable in the target device. The first controller is configured to perform: in a case that the target service is set to the first service for the target device, ordering, as a part of the first service, a new consumable for the target device when the residual quantity is lower than or equal to a first threshold value. The second controller is configured to perform: in a case that the target service is set to the second service for the target device, ordering, as a part of the second service, a new consumable for the target device when the residual quantity is lower than or equal to a second threshold value different from the first threshold value. The first controller is configured to further perform: in a case that a request to modify the target service for the target device to the first service from the second service is received, acquiring specific information in response to the request, the specific information being related to an order placed for the new consumable while the target service has been set to the second service for the target device; and setting the first threshold value on the basis of the specific information.

According to another aspect, the disclosure provides a method. The method includes: in a case that a target service is set to a first service for a target device, ordering, as a part of the first service, a new consumable for the target device when a residual quantity is lower than or equal to a first threshold value, the residual quantity being related to a currently-used consumable in the target device; in a case that the target service is set to the second service for the target device, ordering, as a part of a second service different from the first service, a new consumable for the target device when the residual quantity is lower than or equal to a second threshold value different from the first threshold value; in a case that a request to modify the target service for the target device to the first service from the second service is received, acquiring specific information in response to the request, the specific information being related to an order placed for a new consumable while the target service has been set to the second service for the target device; and setting the first threshold value on the basis of the specific information.

In the above structures, the first threshold value is set on the basis of the specific information related to the order placed for the new consumable while the target service has been set to the second service for the target device. Accordingly, the first threshold value can be appropriately set on the basis of the using history of the second service, thereby preventing a user from incurring any loss or other disadvantages when changing the target service from the second printing service to the first printing service.

### BRIEF DESCRIPTION OF DRAWINGS

FIG. 1 is a block diagram illustrating a system.

FIG. 2A is a flowchart illustrating an ink bottle delivery process.

FIG. 2B is a table for comparing a first printing service and a second printing service.

FIG. 2C is an explanatory diagram illustrating ordering threshold values for the first and second printing services.

FIG. 3 is an explanatory diagram illustrating a management database.

FIG. 4 is a sequence chart illustrating a first part of a service modification process.

FIG. 5 is a sequence chart illustrating a second part of the service modification process.

FIG. 6 is a flowchart illustrating a service termination process.

FIG. 7 is a flowchart illustrating a service initiation process.

FIG. 8 is a flowchart illustrating a threshold adjustment process.

FIG. 9A is a flowchart illustrating a service initiation process.

FIG. 9B is an explanatory diagram illustrating ordering threshold values for the first and second printing services.

FIG. 9C is a table illustrating correspondences between threshold values in a first threshold range and threshold values in a second threshold range.

### DESCRIPTION

### A. Embodiment

### A-1. Configuration of a System 1000

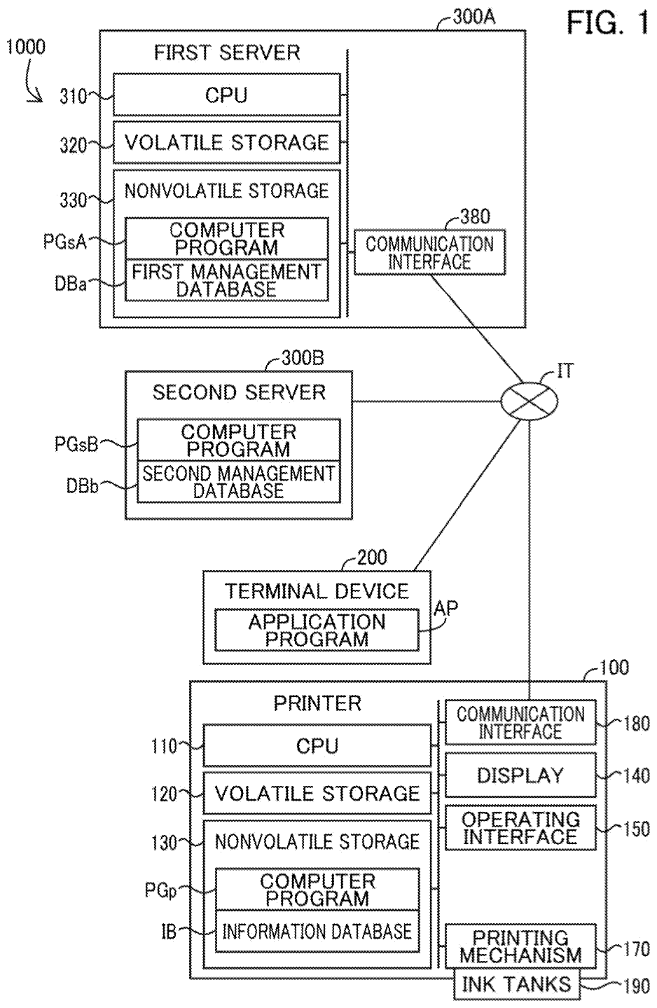

FIG. 1 is a block diagram showing the configuration of a system 1000. The system 1000 is provided with a printer 100, a terminal device 200 owned by the user of the printer 100, a first server 300A, and a second server 300B.

The printer 100 uses ink as the printing material. The ink is consumed by printing operation. The printer 100 is provided with a CPU 110 serving as a controller of the printer 100, a volatile storage 120 such as DRAM, and a nonvolatile storage 130 such as a hard disk drive or flash memory. The printer 100 is also provided with: a display 140, such as a liquid crystal display, for displaying images; an operating interface 150 including buttons, a touchscreen, and the like for receiving user operations; a printing mechanism 170; and a communication interface 180.

The communication interface 180 is an interface for connecting to an internet IT, such as a wired interface compliant with Ethernet or a wireless interface compliant with the Wi-Fi standard. That is, the communication interface 180 is a network interface.

The CPU 110 is an arithmetic device (processor) that performs data processing. The volatile storage 120 provides a buffer area for temporarily storing various intermediate data generated when the CPU 110 executes processes. The nonvolatile storage 130 stores a computer program PGp for controlling the printer 100, and an information database IB that records various types of information described later.

In the present embodiment, the computer program PGp is stored in the nonvolatile storage 130 in advance at the time the printer 100 is manufactured. As an alternative, the computer program PGp may be downloaded from a server connected to the printer 100 via the internet IT or may be recorded on a CD-ROM or other storage medium and supplied in this form.

By executing the computer program PGp, the CPU 110 implements various processes for controlling the printer 100. For example, the CPU 110 executes a printing process by controlling the printing mechanism 170 to print an image. The CPU 110 also executes various processes for providing a first printing service and a second printing service in conjunction with the first server 300A and/or the second server 300B.

The printing mechanism 170 executes printing under control of the CPU 110. The printing mechanism 170 is an inkjet printing mechanism that prints images on recording media using a plurality of types of ink (e.g., ink in the four colors cyan, magenta, yellow, and black) as the color material. The inks are accommodated in ink tanks 190. As an alternative, the printing mechanism 170 may be an electrophotographic printing mechanism that prints images on recording media using toner accommodated in toner cartridges as the color material. The printing mechanism 170 is an example of a print engine.

The terminal device 200 is a computer that is provided with a CPU, a memory, and a display (e.g., a liquid crystal display) not shown in the drawings. For example, the terminal device 200 may be a smartphone. As a variation, the terminal device 200 may be a personal computer or a tablet computer. The terminal device 200 is provided with a prescribed communication interface (not shown), such as a wireless communication interface compliant with the Wi-Fi standard or a mobile communication standard (e.g., the Long Term Evolution (LTE) standard). An application program AP is installed on the terminal device 200. The application program AP controls the CPU of the terminal device 200 to execute processes related to the printing service. Hereinafter, the CPU of the terminal device 200 controlled by the application program AP will be calleted the “terminal application”. The terminal application executes a process for transmitting user information needed for the first printing service and the second printing service to the first server 300A and the second server 300B, for example. This user information may be payment information, such as the user's credit card number.

Each of the first server 300A and the second server 300B is a computer operated by the service provider providing the printing service (e.g., the company that manufactures or sells the printer 100), for example. The first server 300A and the second server 300B are cloud servers, for example.

The first server 300A is provided with a CPU 310 serving as the controller of the first server 300A, a volatile storage 320 such as DRAM, a nonvolatile storage 330 such as a hard disk drive or flash memory, and a communication interface 380. The communication interface 380 is a wired interface compliant with Ethernet, for example. In other words, the communication interface is a network interface.

The CPU 310 is an arithmetic device (a processor) that performs data processing. The volatile storage 320 provides a buffer area for temporarily storing various intermediate data generated when the CPU 310 executes processes. The nonvolatile storage 330 stores a computer program PGsA, and a first management database DBa recording various information described later.

The service provider operating the printing service may provide the first server 300A with the computer program PGsA in an uploaded form, for example. By executing the computer program PGsA, the CPU 310 of the first server 300A implements processes related to the first printing service, such as a service modification process and a process for providing a first printing service described later.

While not shown in the drawings, the second server 300B is provided with components the same as the CPU 310, the volatile storage device 320, the nonvolatile storage device 330, and the communication interface 380 in the first server 300A. However, the nonvolatile storage device 330 in the second server 300B stores a computer program PGsB different from the computer program PGsA, and a second management database DBb different from the first management database DBa.

The service provider operating the printing service may provide the second server 300B with the computer program PGsB in an uploaded form, for example. By executing the computer program PGsB, the CPU 310 of the second server 300B implements processes related to the second printing service, such as a service modification process and a process for providing the second printing service described later.

Although FIG. 1 depicts only one printer 100 and one terminal device 200, the first server 300A and second server 300B provide printing services to many users using many printers. The various processes of the printing services are described below for a single printer 100 and a single terminal device 200, but these processes are executed independently for each of the plurality of printers used with the service (e.g., a printer 100; hereinafter also referred to as the “target printer”). Further, the printer 100 uses one type of ink when a monochrome printer and multiple types of ink (e.g., the four colors cyan, magenta, yellow, and black) when a color printer. Ink-related processes (e.g., ordering ink bottle(s) and managing the order status) are executed independently for each ink type. In the following description, the target printer is a printer 100 that uses a single type of ink.

### A-2. Overview of Printing Services

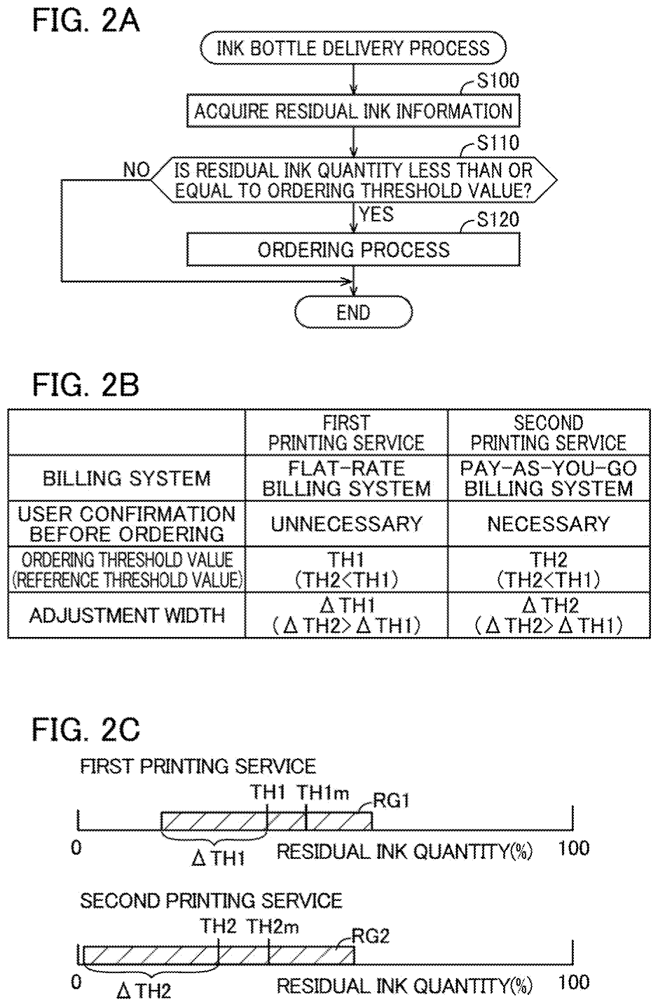

FIGS. 2A-2C are drawings for illustrating the printing services. The first printing service and the second printing service both manage the residual quantity of ink in the ink tank 190 of the printer 100 and ship ink bottle(s) containing ink to the user of the printer 100 for refilling the ink tank 190. FIG. 2A is a flowchart showing an ink bottle delivery process. Each of the first server 300A and the second server 300B executes the ink bottle delivery process periodically, such as once a day. The first server 300A is a server for providing the first printing service and performs the ink bottle delivery process as a part of the first printing service. The second server 300B is a server for providing the second printing service and performs the ink bottle delivery process as a part of the second printing service.

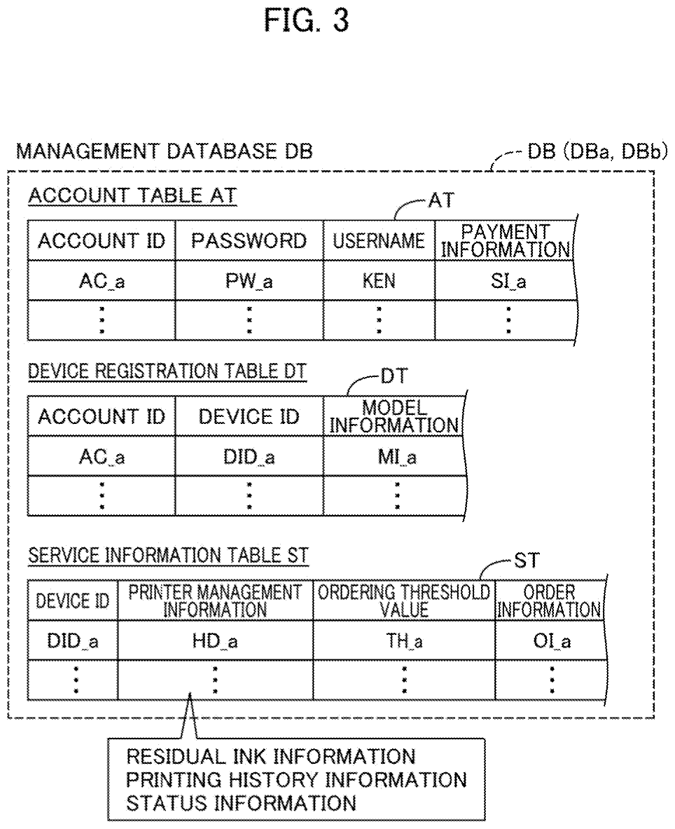

In S100 of the ink bottle delivery process, the CPU 310 acquires residual ink information for the printer 100 from a management database DB (FIG. 3). Here, the management database DB is the first management database DBa (FIG. 1) when the CPU 310 of the first server 300A performs the ink bottle delivery process, whereas the management database DB is the second management database DBb when the CPU 310 of the second server 300B performs the ink bottle delivery process. The residual ink information specifies the residual quantity of ink in the ink tank 190. The residual ink information is included in printer management information (described later) recorded in the management database DB. The printer 100 transmits residual ink information to the server providing the service (e.g., the first server 300A or second server 300B) periodically (e.g., every minute) or each time a print is performed. Specifically, the printer 100 transmits the residual ink information to the first server 300A when a printing service for the printer 100 (a target service) is set to the first printing service, whereas the printer 100 transmits the residual ink information to the second server 300B when the printing service for the printer 100 (the target service) is set to the second printing service. Upon receiving residual ink information from the printer 100, the server (300A or 300B) updates the residual ink information recorded in the management database DB (DBa or DBb).

In S110 the CPU 310 determines whether the residual ink quantity specified by the residual ink information is less than or equal to an ordering threshold value TH. When the residual ink quantity is less than or equal to the ordering threshold value TH (S110: YES), in S120 the CPU 310 executes an ordering process. For example, the CPU 310 sends information necessary for ordering an ink bottle to the company that ships the ink bottle(s). Here, for example, the information necessary for ordering the ink bottle is information on a code specifying the type of ink bottle and a shipping address to which the ink bottle is to be delivered (e.g., the user's name and address). When necessary, the CPU 310 may send an e-mail to the user of the printer 100 during the ink bottle delivery process to confirm that the user wishes to place an order for the ink bottle. In this case, the server orders the ink bottle when receiving a reply approving the order and does not order the ink bottle when receiving a reply declining the order. When the residual quantity of ink exceeds the ordering threshold value TH (S110: NO), the CPU 310 skips the ordering process of S120.

FIG. 2B is a table comparing the first printing service and the second printing service. The first printing service employs a flat-rate billing system. For example, in the first printing service the user pays a flat-rate monthly fee to print up to a prescribed number of printable sheets per month (e.g., a number between several hundred and several tens of thousands of sheets). When the number of printable sheets is exceeded in any month in the first printing service, a surcharge corresponding to the number of excess sheets is added to the flat-rate fee. The flat-rate fee covers charges for printer maintenance and ink refill bottle(s).

The second printing service employs a pay-as-you-go billing system. For example, in the second printing service the user can prepay a fee for a desired number of sheets to be printed and can print the number of sheets for which prepayment has been made. The printing fee covers charges for printer maintenance and ink refill bottle(s).

In the first printing service, ink bottle(s) is (are) ordered automatically without obtaining user confirmation for the following reason. In a conceivable case that user confirmation were required, any delay in receiving this confirmation would delay delivery of the ink bottle to the user. When delivery of the ink bottle is delayed, the printer 100 will run out of ink and be unable to print despite the user having permission to print up to the number of printable sheets, thereby inconveniencing the user. Since the user cannot print in this situation despite having paid the flat-rate fee, the user will suffer considerable loss. Therefore, the first printing service employing the flat-rate system does not confirm with the user before placing an order in the ordering process described above (S120).

In the second printing service, the CPU 310 places an order for ink bottle(s) after obtaining user confirmation. The number of sheets printed in the first printing service employing a flat-rate system is assumed to be relatively constant among users for each plan, for example, but the number of sheets printed in the second printing service employing a pay-as-you-go system can vary considerably among users. That is, variation in the number of sheets printed among different users is likely to be greater in the second printing service than in the first printing service. Further, users of the flat-rate first printing service are generally expected to print a certain amount of sheets each month, while users of the pay-as-you-go second printing service may print more sheets in some periods and less sheets in other periods depending on the time (time of year, for example). Therefore, in a conceivable case that ink bottle(s) were shipped automatically in the second printing service, certain users not planning on printing a large volume will receive shipped ink bottle(s) and have the burden of storing the ink bottle(s). Further, even when a user is unable to print because the printer 100 runs out of ink in the second printing service employing the pay-as-you-go system, the user's loss is less than that in the first printing service employing the flat-rate system because the user's printing fee is also decreased by an amount equivalent to the reduced number of printed sheets. Accordingly, in the ordering process described above (S120), the CPU 310 does not ship ink bottle(s) automatically in the second printing service but only ships ink bottle(s) after receiving confirmation from the user.

FIG. 2C is an explanatory diagram showing an ordering threshold value used for each printing service. For example, the ordering threshold value may be a value in the range 0-100 when the residual ink quantity is expressed as the percentage of ink remaining in the ink tank 190 (units: %). The first printing system employs a first ordering threshold value TH1m defined as a value within a first threshold range RG1. The first threshold range RG1 is centered on a first reference value TH1 and is a range equivalent to 2×ΔTH1. That is, the first ordering threshold value TH1m is defined by (TH1−ΔTH1)≤TH1m≤(TH1+ΔTH1). ΔTH1 is an adjustment width for the first ordering threshold value TH1m and will be called the first adjustment width ΔTH1. Here, the length of the first threshold range RG1 is equal to 2×ΔTH1.

The first ordering threshold value TH1m is set to the first reference value TH1 at the start of the first printing service with no printing history information being stored for the printer 100 in the nonvolatile storage 330. Thereafter, the first ordering threshold value TH1m is adjusted within the first threshold range RG1 according to an adjustment algorithm. The adjustment algorithm adjusts the first ordering threshold value TH1m on the basis of usage history in the first printing service. For example, the greater amount of ink consumed per month, the larger the value to which the first ordering threshold value TH1m is adjusted. Accordingly, the adjusted first ordering thresholding value TH1m is shifted from the first reference value TH1. The CPU 310 may set the first ordering threshold value TH1m on the basis of an adjustment amount obtained from a table specifying correlations between amounts of ink consumed per month and adjustment amounts relative to the first reference value TH1. Although not described in detail herein, the amount of ink consumed per month is estimated on the basis of the actual ink consumption and/or the number of printed sheets calculated from printing history information. As a result, the first ordering threshold value TH1m is set so that ink bottle(s) is (are) ordered at a suitable timing to avoid the printer 100 running out of ink while preventing the user's inventory of ink bottle(s) from growing excessively large.

The second printing service employs a second ordering threshold value TH2m defined as a value within a second threshold range RG2. The second threshold range RG2 is centered on a second reference value TH2 and is a range equivalent to 2×ΔTH2. That is, the second ordering threshold value TH2m is defined by the expression (TH2−ΔTH2)≤TH2m≤(TH2+ΔTH2). ΔTH2 is an adjustment width for the second ordering threshold value TH2m and will be called a second adjustment width ΔTH2. Here, the length of the second threshold range RG2 is equal to 2×ΔTH2.

The second ordering threshold value TH2m is set to the second reference value TH2 when starting the second printing service with no printing history information being stored for the printer 100 in the nonvolatile storage 330. Thereafter, as with the first ordering threshold value TH1m described above, the second ordering threshold value TH2m is adjusted within the second threshold range RG2 according to an adjustment algorithm on the basis of usage history in the second printing service. Accordingly, the adjusted second ordering thresholding value TH2m is shifted from the second reference value TH2.

The first reference value TH1 for the first ordering threshold value TH1m is greater than the second reference value TH2 for the second ordering threshold value TH2m (see FIGS. 2B and 2C). In other words, ink bottle(s) is (are) likely to be ordered with more ink remaining in the ink tank 190 in the first printing service than in the second printing service. This is because the user will suffer greater loss in the flat-rate first printing service when the printer 100 runs out of ink, as described above. Therefore, ink bottle(s) is (are) ordered more quickly in the first printing service than in the second printing service.

Further, the second adjustment width ΔTH2 is greater than the first adjustment width ΔTH1 (see FIGS. 2B and 2C). This is because the variation in the number of sheets printed among users is likely to be greater in the second printing service than in the first printing service, as described above.

### A-3. Management Databases

FIG. 3 is an explanatory diagram of the management database DB. Because the first management database DBa and second management database DBb have the same basic structure, this basic structure will be described with reference to the management database DB shown in FIG. 3, and differences between the first management database DBa and the second management database DBb will be described as needed.

The management database DB includes an account table AT, a device registration table DT, and a service information table ST.

The account table AT is used to register records of user information for users. Each record of user information includes a user account for a user of the printing service and information related to the account. In the present embodiment, each record of user information includes an account ID, a password, a username, and payment information, as illustrated in FIG. 3. In the example of FIG. 3, a record including the account ID “AC_a”, the password “PW_a”, the username “KEN”, and the payment information “SI_a” is registered for the administrative user of the printer 100. While not shown in the drawing, each record of user information in the account table AT has other types of information for the corresponding user necessary for the printing service. The other types of information include the user's address (a shipping address for ink bottle(s)) and the user's e-mail address, for example. The payment information may differ according to the printing service. For example, the first printing service employing the flat-rate system assumes payments will be made by credit card. In this case, the payment information includes a credit card number. In the second printing service employing the pay-as-you-go system, payments could be made using a prepaid card in addition to a credit card. In this case, the payment information also includes a prepaid card number and balance information for the prepaid card, for example.

The device registration table DT is used to register records, each including device information associated with an account ID. Device information in each record includes one or more device IDs for identifying one or more devices, model information for the devices, and the like. This table associates the user identified by an account ID with one or more printers used in relation to the printing service. In the example of FIG. 2, the account ID “AC_a” for the user of the printer 100 is recorded in association with the device ID “DID_a” and the model information “MI_a” of the printer 100.

The service information table ST is used to register records of information related to the printing services for printers used in the printing services. Each record in the service information table ST includes a device ID identifying a printer, printer management information, an ordering threshold value, order information. The printer management information includes the residual ink information described above, printing history information, and status information specifying the printer status (normal, error, etc.), for example.

The printing history information details the history of printing performed in the printer 100. For example, the printing history information includes information correlating numbers of sheets printed with the date and time of their printing. Because ink constitutes a consumable that is consumed when printing, the printing history information can be considered information related to the history of ink consumption. Additionally, because ink is ordered on the basis of ink consumption, the printing history information may be considered as information related to the ordering of ink. Or, the printing history information may include information of ordering history of ink bottles. In this case, the more frequently the orders for the ink bottle(s) are placed in a predetermined period of time, the larger the value to which the first ordering threshold value TH1m may be adjusted. The printing history information is used to adjust the ordering threshold value described above and to count the number of printable sheets corresponding to the printing fee, for example. The server (300A or 300B) periodically receives printing history information from the printer 100 to update the printing history information recorded in the management database DB, for example.

The order information is status information indicating the order status of ink bottle(s). The order status of an ink bottle indicates one of a plurality of stages from a stage at which the ink bottle has been ordered to a stage at which the ink tank 190 has been replenished with ink from the ink bottle. For example, the order status of an ink bottle may include the three stages “order complete,” “delivery complete,” and “replenishment complete.” At the “order complete” stage, an order for the ink bottle has been placed, but the ink bottle has yet to be delivered to the user. At the “delivery complete” stage, the ordered ink bottle has been delivered to the user, but the ink tank 190 has not been refilled with ink from the delivered ink bottle. The server (300A or 300B) updates the order status to “order complete” after the server itself has executed the ink bottle ordering process (see FIG. 2A). The server (300A or 300B) updates the order status to “delivery complete” upon receiving a notification from the shipping company's server specifying that the ink bottle was delivered, for example. The server updates the order status to “replenishment complete” upon receiving a notification from the printer 100 specifying that the ink tank 190 has been refilled with ink, for example.

### A-4. Service Modification Process

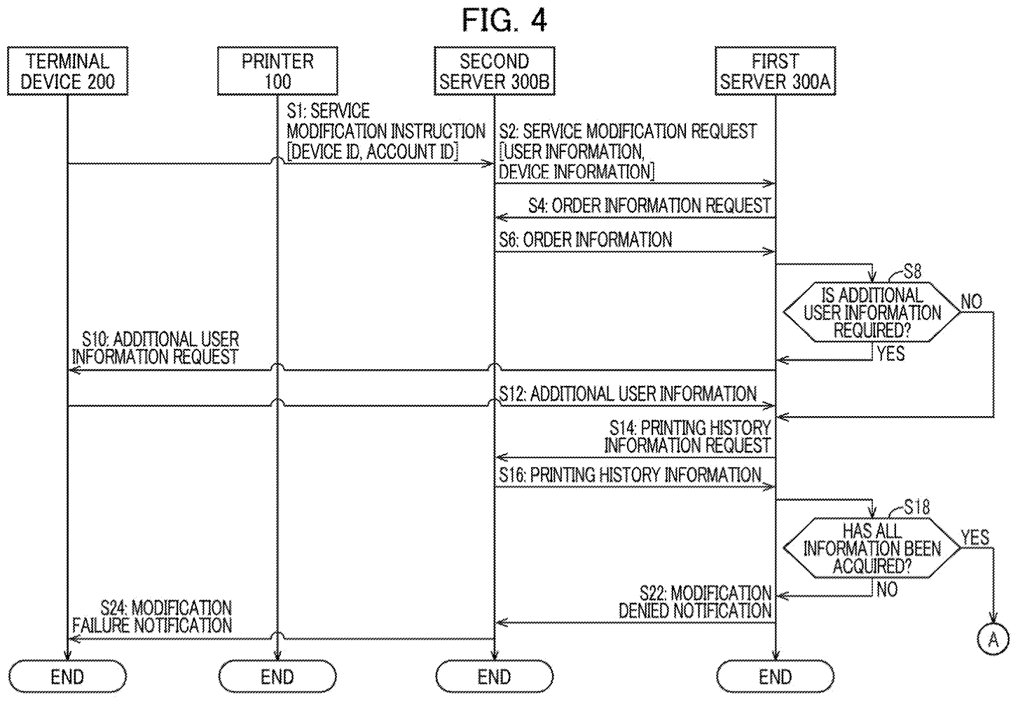

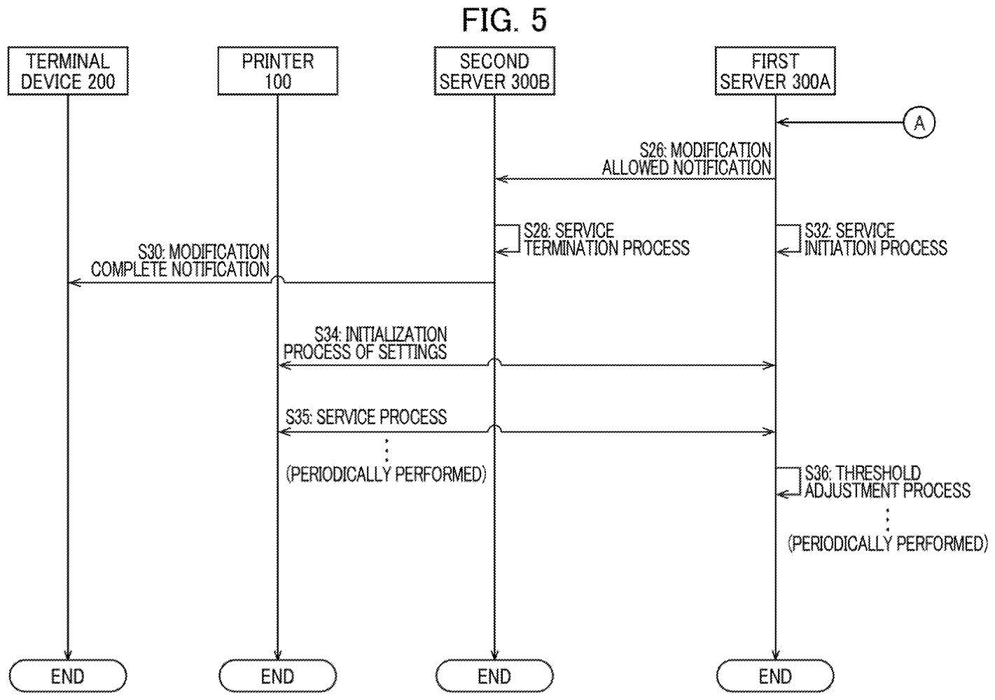

FIGS. 4 and 5 are sequence charts showing a service modification process. The service modification process is performed to change the service used with the printer 100 from one service to another service among a plurality of printing services. The following example describes a case in which the service used with the printer 100 (the target service) is changed from the second printing service to the first printing service.

Thus, when the service modification process in FIG. 4 begins, the user is using the second printing service with the printer 100. Accordingly, user information such as the account ID for this user is recorded in the account table AT of the second management database DBb. The account ID of this user is also recorded in association with the device ID of the printer 100 in the device registration table DT of the second management database DBb. Further, printer management information such as printing history information for the second printing service, the second ordering threshold value TH2m used in the second printing service, and order information specifying the order status of ink bottle(s) in the second printing service are recorded in the service information table ST of the second management database DBb in association with the device ID of the printer 100.

In S1 of FIG. 4, in response to a user operation on the terminal device 200, the terminal device 200 (the terminal application) transmits a service modification instruction to the second server 300B, which provides the second printing service currently in use by the user. The service modification instruction is instruction to terminate use of the second printing service and begin use of the first printing service. The service modification instruction includes the device ID of the printer 100 and the account ID of the user.

Upon receiving the service modification instruction, in S2 the second server 300B transmits a service modification request to the server that provides the target printing service, i.e., the first server 300A in the present embodiment. The service modification request includes the user information and the device information. The user information is the information recorded in the account table AT of the second management database DBb that includes the account ID matching the account ID included in the service modification instruction. The device information is the information recorded in the device registration table DT of the second management database DBb that includes the device ID matching the device ID included in the service modification instruction. The first server 300A records the user information and device information included in the service modification request received from the second server 300B in the account table AT and the device registration table DT of the first management database DBa.

In S4 the first server 300A transmits an order information request to the second server 300B requesting order information (see FIG. 3) on the printer 100 that is the subject of the service modification process. The order information request may include the device ID received in S2. Upon receiving the order information request, in S6 the second server 300B transmits the order information for the printer 100 to the first server 300A.

In S8 the first server 300A determines whether additional user information is required. In other words, the required user information may differ depending on the printing service. For example, when payment is made with a prepaid card in the second printing service but payment by prepaid card is not supported in the first printing service, information needed for payment in the first printing service, such as a credit card number, is required for the first printing service. In this case, the first server 300A determines that additional user information is required.

When the additional user information is required (S8: YES), in S10 the first server 300A transmits an additional user information request to the terminal device 200. The additional user information request is sent to the terminal application on the terminal device 200, for example. Upon receiving the additional user information request, in S12 the terminal device 200 transmits the additional user information to the first server 300A. As an example, the additional user information request includes a uniform resource locator (URL) of a web page used for entering additional user information. The terminal device 200 accesses the web page in response to user operations. After the user has inputted the additional user information in the entry fields of this web page, the terminal device 200 sends the additional user information to the first server 300A. The server 300A receives the additional user information from the terminal device 300. When additional user information is not required (S8: NO), the first server 300A skips the process in S10 and S12.

In S14 the first server 300A transmits a history information request to the second server 300B requesting printing history information for the current printing service (pre-change printing service), which is the second printing service in this example. The history information request may include the device ID received in S2. Upon receiving the history information request, in S16 the second server 300B transmits the printing history information for the printer 100 stored in the service information table ST of the second management database DBb to the first server 300A.

In S18 the first server 300A determines whether all information required for starting the first printing service has been acquired. When there remains required information that could not be acquired (S18: NO), in S22 the first server 300A transmits a modification denied notification to the second server 300B indicating that the change to the first printing service has been denied.

Upon receiving the modification denied notification, in S24 the second server 300B transmits a modification failure notification to the terminal device 200. The modification failure notification indicates that the change to the first printing service has been failed.

When all required information is acquired (S18: YES), in S26 of FIG. 5 the first server 300A transmits, to the second server 300B, a modification allowed notification indicating that the change to the first printing service has been permitted.

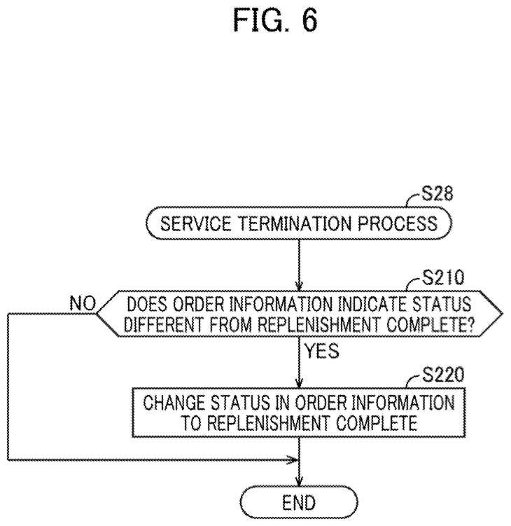

Upon receiving the modification allowed notification, in S28 the second server 300B executes a service termination process for terminating the second printing service. FIG. 6 is a flowchart illustrating steps in the service termination process. In S210 of FIG. 6, the second server 300B determines whether the order information for the printer 100 indicates a status different from “replenishment complete.” In the present embodiment, a status different from “replenishment complete” in the order information for the printer 100 may be one of the two types “order complete” and “delivery complete.”

When the order information specifies a status other than “replenishment complete” (S210: YES), in S220 the second server 300B changes the status in the order information to “replenishment complete.” This change is performed because the second server 300B no longer needs to manage the status since the first server 300A will take over the management of statuses from the ordering of ink bottle(s) to the completion of ink replenishment, as will be described below. When the order information indicates “replenishment complete” (S210: NO), the second server 300B skips the process of S220.

After completing the service termination process in S28 shown in FIG. 5, in S30 the second server 300B transmits, to the terminal device 200, a modification complete notification indicating that modification of the printing service to the first printing service has been successful. The terminal device 200 may notify the user that the modification has been completed by displaying the modification complete notification on a display, for example.

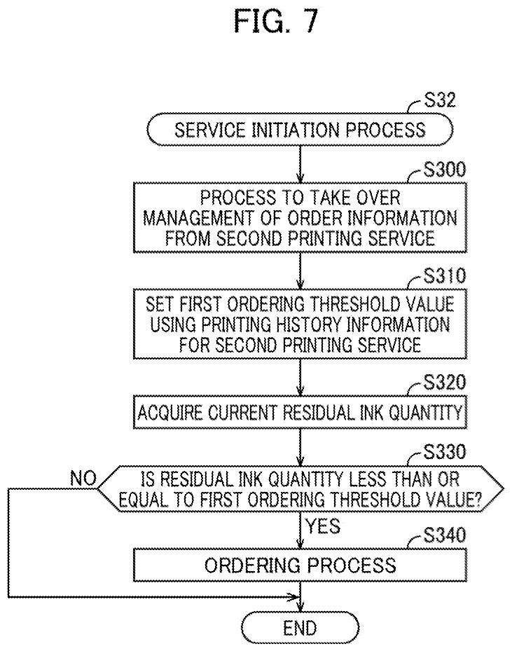

In the meantime, after transmitting the modification allowed notification in S26, in S32 the first server 300A executes a service initiation process for starting the first printing service. FIG. 7 is a flowchart illustrating steps in the service initiation process. In S300 of FIG. 7, the first server 300A executes a process to take over the management of the order information from the second printing service. Specifically, the first server 300A records the order information received in S6 of FIG. 4 in the service information table ST of the first management database DBa in association with the device ID for the printer 100. Thereafter, the first server 300A manages the order status of ink bottle(s) for the printer 100. The management of the order status includes monitoring and updating the order status, for example.

In S310 the first server 300A uses the printing history information for the second printing service to set the first ordering threshold value TH1m for the first printing service. As described above, the first ordering threshold value TH1m is set using printing history information according to an adjustment algorithm. The first server 300A records this first ordering threshold value TH1m in the service information table ST of the first management database DBa in association with the device ID for the printer 100. By executing the process of S310, the target service for the printer 100 is modified to the first printing service from the second printing service.

In S320 and S330 the first server 300A determines whether it is necessary to order an ink bottle. Specifically, in S320 the management server 300 acquires the current residual ink quantity in the printer 100 from the second server 300B. In S330 the first server 300A determines whether the current residual ink quantity in the printer 100 is less than or equal to the first ordering threshold value TH1m newly set in S310. When the current residual ink quantity is less than or equal to the first ordering threshold value TH1m (S330: YES), in S340 the first server 300A executes an ordering process for ink bottle(s) similar to the process of S110 (FIG. 2A). However, when the residual ink quantity is greater than the first ordering threshold value TH1m (S330: NO), the first server 300A skips the ordering process of S340.

In S34 of FIG. 5 following the service initiation process, the first server 300A and the printer 100 execute an initialization process of settings for the first printing service. For example, the first server 300A transmits information to the printer 100 specifying the type of information that the printer 100 should periodically send to the first server 300A, and the destination (URL) for sending the information.

After completing the initialization process, in S35 the first server 300A and the printer 100 begin a service process for the first printing service. That is, the printer 100 periodically sends printing history information and residual ink information to the first server 300A. In other words, the first server 300A periodically executes the bottle delivery process shown in FIG. 2A. The first server 300A manages the residual ink quantity in the printer 100 on the basis of this residual ink information and executes an ink bottle ordering process when the residual ink quantity in the printer 100 drops to the first ordering threshold value TH1m or below. The first server 300A also manages the order status of ink bottle(s) for the printer 100 using the order information recorded in the first management database DBa. For example, the first server 300A updates the order status of an ink bottle on the basis of information received from the printer 100 or the server of the shipping company.

After the service process for the first printing service is initiated, in S36 the first server 300A executes a threshold adjustment process. In this process, the first server 300A modifies the first ordering threshold value TH1m using the printing history information for the printer 100. The first server 300A executes the threshold adjustment process periodically at prescribed intervals (e.g., every few days) after starting the first printing service.

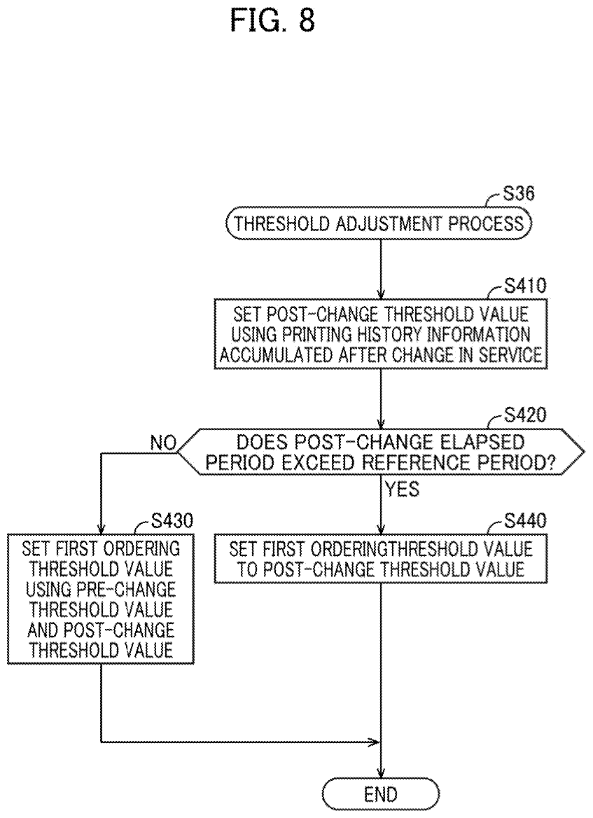

FIG. 8 is a flowchart illustrating steps in the threshold adjustment process. In S410 of FIG. 8, the first server 300A sets a post-change threshold value THb on the basis of printing history information accumulated after the change in service. For example, after starting the first printing service, the first server 300A records printing history information received from the printer 100 in the service information table ST. Using this new printing history information, the first server 300A sets the post-change threshold value THb according to an adjustment algorithm. The post-change threshold value THb is set according to the same algorithm used in S310 of FIG. 7 for setting the first ordering threshold value TH1m on the basis of printing history information for the second printing service.

In S420 the first server 300A determines whether a post-change elapsed period Tp exceeds a reference period Tr. The post-change elapsed period Tp is a period of time from the start of the first printing service to the present. The reference period Tr is set to a period of time necessary for collecting printing history information required for calculating a sufficiently suitable first ordering threshold value TH1m according to the adjustment algorithm, for example.

When the post-change elapsed period Tp is greater than the reference period Tr (S420: YES), in S440 the first server 300A sets the first ordering threshold value TH1m to the post-change threshold value THb that has been set in S410. Since sufficient printing history information has been accumulated for the first printing service in this case, the post-change threshold value THb set on the basis of solely on printing history information for the first printing service is likely suitable for use as the first ordering threshold value TH1m.

When the post-change elapsed period Tp is no greater than the reference period Tr (S420: NO), in S430 the first server 300A sets the first ordering threshold value TH1m on the basis of a pre-change threshold value THa and the post-change threshold value THb set in S410. Here, the pre-change threshold value THa is equal to the first ordering threshold value TH1m that has been set in S310 of the service initiation process described in FIG. 7. In other words, the pre-change threshold value THa is set on the basis of the printing history information for the second printing service.

Note that the first ordering threshold value TH1m is calculated by combining the pre-change threshold value THa and the post-change threshold value THb using weights Wa and Wb determined on the basis of the post-change elapsed period Tp. Specifically, the first ordering threshold value TH1m is calculated according to the following equations (1)-(3).

$$TH 1 m = Wa \times THa + Wb \times THb \qquad ( 1 )$$

$$Wa = ( T r - Tp ) / Tr \qquad ( 2 )$$

$$Wb = Tp / Tr \qquad ( 3 )$$

After setting a new first ordering threshold value TH1m according to the threshold adjustment process, the first server 300A determines whether to order an ink bottle on the basis of this first ordering threshold value TH1m.

According to the embodiment described above, the first server 300A manages the residual ink quantity in the printer 100 and orders an ink bottle when the residual ink quantity in the printer 100 drops to the first ordering threshold value TH1m or below (see FIG. 2A). The first server 300A acquires the service modification request to change the service used with the printer 100 from the second printing service to the first printing service, which is the service that the first server 300A provides (S2 of FIG. 4). After receiving the service modification request, the first server 300A acquires the printing history information for the second printing service using the printer 100 (S16 of FIG. 4). The printer 100 sets the first ordering threshold value TH1m on the basis of this history information (S32 of FIG. 5, S310 of FIG. 7). Thus, the first server 300A can set a suitable first ordering threshold value TH1m that accounts for usage conditions in the second printing service using the printer 100, for example. Hence, this process prevents the user of the printer 100 from incurring any loss or other disadvantages when changing from the second printing service to the first printing service.

In a conceivable case that the first server 300A were to set the first ordering threshold value TH1m to the first reference value TH1 for a user of the printer 100 that prints a large volume, the shipment of ink bottle(s) may be too late, resulting in the printer 100 running out of ink. In the present embodiment, the first server 300A uses printing history information specifying that a large amount of printing was performed in the second printing service to set the first ordering threshold value TH1m to a value larger than the first reference value TH1. Consequently, ink bottle(s) is (are) ordered at an earlier timing to avoid the printer 100 running out of ink.

Conversely, in a conceivable case that the first server 300A sets the first ordering threshold value TH1m to the first reference value TH1 for a user of the printer 100 that prints a low volume, ink bottle(s) may be shipped to the user too quickly, resulting in the user's ink inventory becoming too large. In the present embodiment, the first server 300A uses printing history information specifying that only a small amount of printing was performed with the second printing service to set the first ordering threshold value TH1m to a value smaller than the first reference value TH1. Consequently, ink bottle(s) is (are) ordered at a later timing to avoid the user's ink inventory becoming excessively large.

The first server 300A according to the present embodiment further adjusts the first ordering threshold value TH1m from the first reference value TH1 using the printing history information, i.e., history information related to ink consumption (FIG. 2C, S310 of FIG. 7). As a result, the first server 300A can set a suitable first ordering threshold value TH1m that accounts for the actual amounts of ink consumed in the second printing service. Thus, the first server 300A can avoid the case described above in which the printer 100 runs out of ink and the case in which the user's ink inventory becomes excessively large.

After starting the first printing service, the first server 300A according to the embodiment uses printing history information for the first printing service to adjust the first ordering threshold value TH1m (S36 of FIG. 5 and FIG. 8). As a result, the first server 300A can consider actual amounts of ink consumption in the first printing service after the first printing service was initiated, so as to suitably adjust the first ordering threshold value TH1m. For example, the user's printing volume may change when the user switches to a different printing service. Even in such cases, the first server 300A can suitably adjust the first ordering threshold value TH1m in response to the change in the user's actual ink consumption.

According to the embodiment, the first server 300A calculates the first ordering threshold value TH1m to be used following a change in service by combining the pre-change threshold value THa, which is set using the printing history information for the second printing service, and the post-change threshold value THb, which is set using the printing history information for the first printing service, using the weights Wa and Wb determined on the basis of the post-change elapsed period Tp (S430 of FIG. 8, equations (1)-(3)). As a result, the first server 300A can calculate the suitable first ordering threshold value TH1m, even when the amount of time elapsed since the start of the first printing service is insufficient.

When the post-change elapsed period Tp exceeds the reference period Tr in the above embodiment, the first server 300A sets the first ordering threshold value TH1m using the printing history information for the first printing service but not the pre-change threshold value THa set using the printing history information for the second printing service (S440 of FIG. 8). Thus, the first server 300A can set the suitable first ordering threshold value TH1m using only the printing history information for the first printing service after a sufficient amount of time has elapsed since the start of the first printing service, i.e., after sufficient printing history information has been accumulated in the first printing service.

According to the above embodiment, the first server 300A acquires the order information indicating the current order status of ink bottle(s) for the printer 100 in the second printing service (S6 of FIG. 4). The first server 300A manages the order status of ink bottle(s) and updates the order information after starting the first printing service. Thus, the first server 300A can take over and manage the order status of ink bottle(s) ordered in the second printing service, avoiding such issues as a duplicate order being placed in the first printing service for ink bottle(s) that has (have) been already ordered in the second printing service. Further, the printing service for the printer 100 can be quickly changed from the second printing service to the first printing service, regardless the order status of ink bottle(s) in the second printing service.

As is clear from the above description, ink and ink bottles in the above embodiment are examples of a consumable, the printer is an example of a device that consumes a consumable, and the printing history information is an example of the specific information. When the printer 100 is a laser printer, toner and cartridges accommodating toner are examples of a consumable.

### B. Variations of the Embodiment

(1) In the service initiation process (FIG. 7) of the above embodiment, the printing history information for the second printing service prior to changing services is used for initially setting the first ordering threshold value TH1m after changing the service to the first printing service. However, other information may be used for setting the first ordering threshold value TH1m in the service initiation process.

In this variation, the first server 300A transmits a threshold request instead of the history information request to the second server 300B in S14 of FIG. 4 requesting the second ordering threshold value TH2m used for the printer 100 in the second printing service. In S16 of FIG. 4, the second server 300B transmits the second ordering threshold value TH2m recorded in the service information table ST of the second management database DBb to the first server 300A instead of the printing history information. In this variation, the second ordering threshold value TH2m is used when initially setting the first ordering threshold value TH1m.

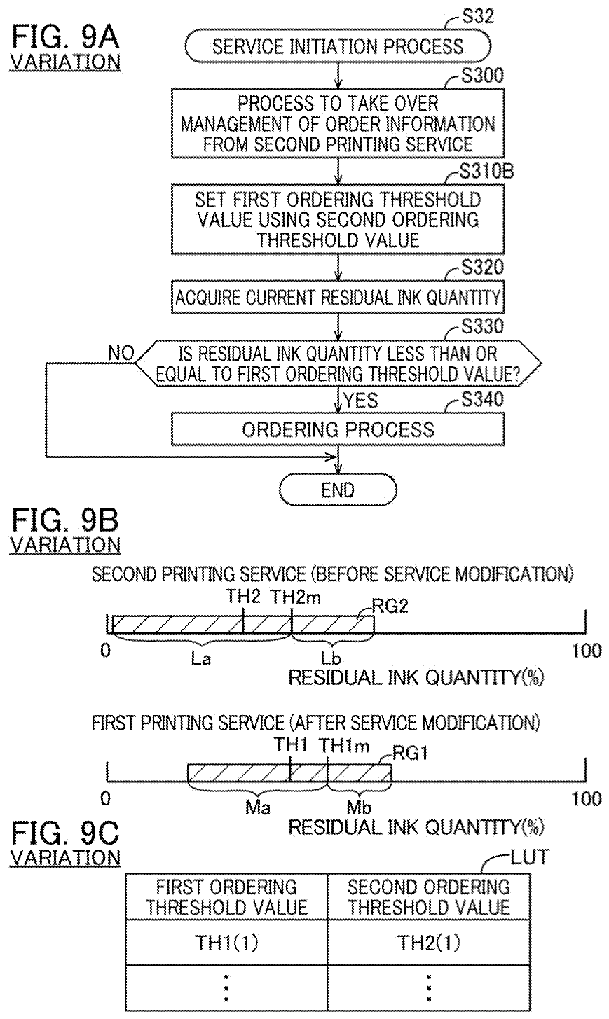

FIGS. 9A-9C are diagrams illustrating this variation. The flowchart shown in FIG. 9A is identical to that in FIG. 7, except that step S310 of FIG. 7 is replaced with the process in S310B of this variation. All other steps in FIG. 9A are the same as those in FIG. 7. In S310B the first server 300A sets the first ordering threshold value TH1m using the second ordering threshold value TH2m received from the second server 300B.

As shown in FIG. 9B, a difference between the upper limit of the second threshold range RG2 and the second ordering threshold value TH2m for the second printing service will be called a difference Lb, while a difference between the second ordering threshold value TH2m and the lower limit of the second threshold range RG2 will be called a difference La. Similarly, a difference between the upper limit of the first threshold range RG1 and the first ordering threshold value TH1m being set for the first printing service will be called a difference Mb, while a difference between the first ordering threshold value TH1m and the lower limit of the first threshold range RG1 will be called a difference Ma. In this case, the first server 300A sets the first ordering threshold value TH1m so that the ratio of the difference La to the difference Lb is equivalent to the ratio of the difference Ma to the difference Mb.

As shown in FIG. 9C, a plurality of threshold values TH1(k) in the first threshold range RG1 corresponding to a plurality of threshold values TH2(k) in the second threshold range RG2 is calculated in advance, and a look-up table LUT having these correspondences is generated in advance, for example. Here, k is an integer of 1 or greater. The threshold values TH1(k) are values corresponding to the first ordering threshold value TH1m, and the threshold values TH2(k) are to be compared with the second ordering threshold value TH2m. The look-up table LUT is stored in the nonvolatile storage device 330 of the first server 300A. By referencing the look-up table LUT, the first server 300A identifies the first ordering threshold value TH1m corresponding to the second ordering threshold value TH2m received from the second server 300B. The first server 300A then sets the identified first ordering threshold value TH1m as the initial first ordering threshold value TH1m to be used at the start of the first printing service. For example, the CPU 310 of the first server 300A finds, from among the plurality of threshold values TH2(k), a threshold value TH2(k) that matches the second ordering threshold value TH2m received from the second server 300B, and identifies, as the first ordering threshold value TH1m, the threshold value TH1(k) corresponding to the found threshold value TH2(k) in the look-up table LUT. In a case that the CPU 310 can find no threshold value TH2(k) matching the second ordering threshold value TH2m, the CPU 310 may search the look-up table LUT for a threshold value TH2(k) closest to the second ordering threshold value TH2m, and identifies, as the first ordering threshold value TH1m, the threshold value TH1(k) corresponding to the found threshold value TH2(k) in the look-up table LUT. Alternatively, in a case that the CPU 310 can find no threshold value TH2(k) matching the second ordering threshold value TH2m, the CPU 310 may calculate the first ordering threshold value TH1m by interpolation or extrapolation using two or more threshold values TH1(k) corresponding to two or more threshold values TH2(k) closest to the second ordering threshold value TH2m found from the look-up table LUT.

In this variation, the first ordering threshold value TH1m is set on the basis of the second ordering threshold value TH2m acquired from the second server 300B. Thus, as in the above embodiment, the first server 300A in this variation can set the suitable first ordering threshold value TH1m. For example, the second ordering threshold value TH2m is set to reflect actual printing results in the second printing service. Therefore, by setting the first ordering threshold value TH1m on the basis of the second ordering threshold value TH2m, the first server 300A can set the suitable first ordering threshold value TH1m that indirectly reflects the actual printing results in the second printing service.

Because this variation employs the look-up table LUT that defines correspondences between first ordering threshold values TH1m and second ordering threshold values TH2m, the first server 300A can easily set a first ordering threshold value TH1m by referencing the look-up table LUT. However, the first ordering threshold value TH1m may be calculated according to a following formula for example rather than using the look-up table LUT: TH1m=TH1−ΔTH1+Mb×(La/Lb).

(2) The initial first ordering threshold value TH1m used at the start of the first printing service may be set on the basis of information other than the printing history information and the second ordering threshold value TH2m for the second printing service. For example, this initial first ordering threshold value TH1m may be set on the basis of the average interval between ink bottle orders in the second printing service. In this case, the shorter the average interval of ink bottle orders, the larger the value set for the first ordering threshold value TH1m, for example.

(3) The service modification process and the processes performed following a change in service may be modified as appropriate from the processes described above. For example, in a case the service is changed to one of some types of printing services, the threshold adjustment process need not be performed after the service process of the changed service is initiated. Alternatively, the threshold adjustment process may be performed after sufficient printing history information has been accumulated. In this case, the post-change threshold value set in S410 of FIG. 8 is always set to the new first ordering threshold value TH1m. That is, in this case, in the threshold adjustment process shown in FIG. 8, the processes of S420 and S430 are omitted and the process S440 is directly performed after the process of S440.

(4) The first server 300A may allow a change in service even when some printing history information could not be acquired from the second server 300B. In this case, the initial first ordering threshold value TH1m at the start of the first printing service is set to the first reference value TH1, for example.

(5) When the printing service is modified, the order status of ink bottle(s) that has (have) been ordered in the printing service used prior to the change in service need not be taken over by the server providing the printing service following the change. In this case, the server providing the pre-change printing service may continue to manage the order status of ink bottle(s) and may notify the server providing the printing service following the change when the order status for all types of ink are “replenishment complete.” The server providing the printing service following the change may then start the ordering process for new ink bottle(s) after receiving this notification.

(6) The first and second services in the above embodiment are not limited to services provided using printers but may be services provided using various other devices that consume some type of consumable, such as water dispensers that supply water or various devices that consume fuel when operated.

(7) In the above embodiment, the first printing service and the second printing service are provided by separate servers. However, one server may provide both the first printing service and the second printing service. Further, an account management server that manages the account table AT may be separate from a server that: manages the device registration table DT and the service information table ST; and provides the services. In this case, the first and second printing services may be provided by three servers: an account management server, a server that provides the first printing service, and a server that provides the second printing service.

(8) Part of the configuration in hardware the embodiments described above may be replaced by software and, conversely, part of the configuration implemented in software may be replaced by hardware.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A server comprising:
a communication interface configured to communicate with a target device, the target device being configured to consume a consumable; and
a controller configured to perform:
receiving a request to modify a target service for the target device to a first service from a second service different from the first service, each of the first service and the second service being a service in which a new consumable is to be ordered for the target device on the basis of a residual quantity related to a currently-used consumable in the target device;
acquiring specific information in response to the request, the specific information being related to an order placed for a new consumable while the target service has been set to the second service for the target device;
setting a first threshold value on the basis of the specific information; and
ordering, as a part of the first service, a new consumable for the target device when the residual quantity is lower than or equal to the first threshold value.

2. The server according to claim 1, wherein the specific information includes second-service history information, the second-service history information being information related to a history of consumption of the consumable used in the target device in a period of time for which the target service has been set to the second service,
wherein the setting sets the first threshold value by adjusting a first reference threshold value on the basis of the second-service history information.

3. The server according to claim 1, wherein in a case that the target service is set to the second service, an order for a new consumable is placed in response to an event that the residual quantity becomes lower than or equal to a second threshold value,
wherein the second threshold value is set by adjusting a second reference threshold value on the basis of second-service history information, the second-service history information being information related to a history of consumption of the consumable used in the target device in a period of time for which the target service is set to the second service,
wherein the specific information includes the second threshold value,
wherein the setting sets the first threshold value on the basis of the second threshold value.

4. The server according to claim 3, further comprising:
a storage,
wherein the setting sets the first threshold value by referencing correspondence information stored in the storage, the correspondence information including one or more correspondences, each correspondence correlating a first type value with a second type value, the first type value being a value within a first range within which the first threshold value can be set, the second type value being a value within a second range within which the second threshold value can be set.

5. The server according to claim 1, wherein the controller is configured to further perform:
modifying the first threshold value on the basis of first-service history information, the first-service history information being information related to a history of consumption of the consumable used in an elapsed period of time since modification of the target service to the first service from the second service.

6. The server according to claim 5, wherein the modifying modifies the first threshold value to a weighted sum of the first threshold value and a specific threshold value, the specific threshold value being obtained on the basis of the first-service history information, at least one weight used in the weighted sum being based on the elapsed period of time since the modification of the target service to the first service from the second service.

7. The server according to claim 5, wherein in a case that the elapsed period of time exceeds a reference period, the modifying modifies the first threshold value on the basis of the specific threshold value without using the first threshold value set by the setting.

8. The server according to claim 1, wherein the controller is configured to further perform:
acquiring status information related to a current order status of the order placed for the new consumable for the target device while the target service has been set to the second service for the target device; and
monitoring, after the target service has been modified to the first service from the second service, the current order status to update the status information,
wherein the current order status can be any one of a plurality of statuses including a status in which the order for the new consumable is completed and a status in which replenishment of the target device with the new consumable is completed.

9. A system comprising:
a first server for providing a first service, comprising:
a first communication interface configured to communicate with a target device, the target device being configured to consume a consumable; and
a first controller; and
a second server for providing a second service different from the first service, comprising:
a second communication interface configured to communicate with the target device; and
a second controller,
wherein each of the first service and the second service is a service in which a new consumable is to be ordered for the target device on the basis of a residual quantity related to a currently-used consumable in the target device,
wherein the first controller is configured to perform:
in a case that the target service is set to the first service for the target device,
ordering, as a part of the first service, a new consumable for the target device when the residual quantity is lower than or equal to a first threshold value,
wherein the second controller is configured to perform:
in a case that the target service is set to the second service for the target device,
ordering, as a part of the second service, a new consumable for the target device when the residual quantity is lower than or equal to a second threshold value different from the first threshold value,
wherein the first controller is configured to further perform:
in a case that a request to modify the target service for the target device to the first service from the second service is received,
acquiring specific information in response to the request, the specific information being related to an order placed for the new consumable while the target service has been set to the second service for the target device; and
setting the first threshold value on the basis of the specific information.

10. A method comprising:
in a case that a target service is set to a first service for a target device,
ordering, as a part of the first service, a new consumable for the target device when a residual quantity is lower than or equal to a first threshold value, the residual quantity being related to a currently-used consumable in the target device;
in a case that the target service is set to the second service for the target device,
ordering, as a part of a second service different from the first service, a new consumable for the target device when the residual quantity is lower than or equal to a second threshold value different from the first threshold value;
in a case that a request to modify the target service for the target device to the first service from the second service is received,
acquiring specific information in response to the request, the specific information being related to an order placed for a new consumable while the target service has been set to the second service for the target device; and
setting the first threshold value on the basis of the specific information.
